(19) United States
(12) Patent Application Publication
(10) Pub. No.: US 2008/0315005 A1
(43) Pub. Date: Dec. 25, 2008

(54) Active material emitting device and method of dispensing an active material

(76) Inventors: Kenneth W. Michaels, Spring Grove, IL (US); Nathan R. Westphal, Union Grove, WI (US)

Correspondence Address: S.C. JOHNSON & SON, INC., 1525 HOWE STREET, RACINE, WI, 53403-2236, US

(21) Appl. No.: 11/821,695

(22) Filed: Jun. 25, 2007

(51) Int. Cl. B05B 17/06; B05B 1/08

(52) U.S. Cl. 239/4; 239/102.2

(57) ABSTRACT

An active material emitting device includes an ultrasonic atomizer disposed within the device for volatilizing an active material. The device further includes an opening disposed adjacent the ultrasonic atomizer for emitting the volatilized active material therethrough. A vent is disposed in the device, wherein the vent creates an air passageway for air to enter the device and exit the device through the opening to carry the volatilized active material away from the device.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to diffusion devices, and more particularly, to diffusion devices for dispensing an active material into an area surrounding such devices.

2. Description of the Background of the Invention

Active material emitting devices are generally known. For example, it is known to emit fragrance from an aerosol container upon the activation of a trigger by a user. Also, other methods utilize the evaporative properties of liquids, or other vaporizable materials, to cause vapors with desired properties to be distributed into the ambient air. One or more heaters and/or fans are often used to vaporize and/or disperse an active material into the ambient air. As a further example of active material emitting device, it is also known to utilize an atomizer assembly to release insecticide or a fragrance from a wick in fluid communication with a reservoir.

One volatile substance dispensing device includes a reservoir with a liquid active material disposed therein and a porous membrane disposed on a bottom surface of the reservoir. The device is disposed on a stand having legs that space the porous membrane from a support surface, wherein the legs include openings therein. The porous membrane allows the liquid active material to move through the membrane to a bottom, exposed surface of the membrane to be evaporated by a natural air flow that travels between the bottom surface and the legs of the device and through the openings in the legs.

Another dispensing device includes inner and outer housings, wherein a package or envelope containing an active ingredient is disposed within the inner housing. A first dispensing opening in the form of slots is disposed in a top portion of the outer housing. The device includes means on the inner and outer housings for moving same between a first position in which the first dispensing opening is in registry with an open end of the inner housing and a second position in which the first dispensing opening is not in registry with the open end of the inner housing. The device further includes legs extending from a bottom portion thereof and a second dispensing opening in the bottom portion such that air moves through the legs, into the inner housing through the second dispensing opening, and out the top of the device through the first dispensing opening.

A further device for dispensing a vaporizable material includes a base, a cover disposed over the base, and an air freshener element disposed between the cover and the base. The cover is supported on the base by guide rails to define an air passage extending between opposite ends of the base and communicating with the air freshener element. The cover includes a baffle means having a plurality of elongated slots, wherein each of the slots communicates with the air passage to dispense air freshener. The baffle means includes means for opening and closing the air passage.

A further device designed for localized delivery of scented aerosols includes a housing having a venting chamber, an aperture, and a plurality of cartridges containing scents. The scents are emitted from the cartridges into the venting chamber and thereafter, a bolus generator disposed within the housing is activated to emit pulses of the fragrance(s) in the venting chamber through the aperture into the surroundings.

Vibratory-type liquid atomization devices are also known and described in Helf et al. U.S. Pat. No. 6,293,474, Martin et al. U.S. Pat. No. 6,341,732, Tomkins et al. U.S. Pat. No. 6,382,522, Martens, III et al. U.S. Pat. No. 6,450,419, Helf et al. U.S. Pat. No. 6,706,988, and Boticki et al. U.S. Pat. No. 6,843,430, all of which are assigned to the assignee of the present application and which are hereby incorporated by reference herein. These patents disclose devices comprising piezoelectric actuating elements coupled to liquid atomization plates. The piezoelectric actuating elements vibrate the liquid atomization plates in response to alternating electrical voltages applied to the actuating elements. The vibration of the plates causes atomization of a liquid supplied by liquid delivery systems. Electrical circuits are provided to supply the alternating electrical voltages to conductive elements that are in electrical contact with opposite sides of the actuating elements. The conductive elements may also serve to support the actuating elements and the liquid atomization plates in housings that contain the devices.

### SUMMARY OF THE INVENTION

According to one aspect of the present invention, an active material emitting device includes an ultrasonic atomizer disposed within the device for volatilizing an active material. The device further includes an opening disposed adjacent the ultrasonic atomizer for emitting the volatilized active material therethrough. A vent is disposed in the device, wherein the vent creates an air passageway for air to enter the device and exit the device through the opening to carry the volatilized active material away from the device.

According to another aspect of the present invention, an active material emitting device includes a base portion, a cover portion disposed over the base portion, and a housing extending upwardly from the base portion and including an ultrasonic atomizer. An opening is disposed in the cover portion and aligned with the ultrasonic atomizer for emitting a volatilized active material therethrough. A vent extends through the base portion and creates an air passageway with the opening.

According to yet a further aspect of the present invention, a method of dispensing an active material includes the step of providing an active material emitting device having a base portion, a cover portion, and an ultrasonic atomizer that volatilizes an active material and dispenses same through an opening in the cover portion. The method further includes the step of creating an ambient air flow into the device through the base portion, through the device, and out the opening.

Other aspects and advantages of the present invention will become apparent upon consideration of the following detailed description, wherein like structures are given like reference numerals.

### BRIEF DESCRIPTION OF THE DRAWINGS

FIG. 1 is a top isometric view of an active material emitting device;

FIG. 2 is a side elevational view of a first side of the device of FIG. 1;

FIG. 3 is a side elevational view of a second side of the device of FIG. 1;

FIG. 4 is a top isometric view of the device of FIG. 1 with a cover portion removed therefrom;

FIG. 5 is a top isometric view of the device of FIG. 1 with the cover portion and a cap removed therefrom;

FIG. 6 is a view similar to FIG. 5 with a housing cover removed therefrom;

FIG. 7 is a is a bottom trimetric view of the housing cover of the device of FIG. 1;

FIG. 8 is an enlarged side elevational view of the cover portion of FIG. 1;

FIG. 9 is a cross-sectional view of the cover portion taken generally along the lines 9-9 of FIG. 1;

FIG. 10 is a partial cross-sectional view taken generally along the lines 10-10 of FIG. 1;

FIG. 11 is a partial cross-sectional view taken generally along the lines 11-11 of FIG. 1;

FIG. 12 is a bottom isometric view of the device illustrated in FIG. 5;

FIG. 13 is a bottom elevational view of the device of FIG. 1;

FIG. 14 is an enlarged, exploded top isometric view of an atomizer assembly of the device of FIG. 1;

FIG. 15 is a top isometric view of a fluid reservoir for insertion into the diffusion device of FIG. 1 as shown in FIGS. 10 and 11;

FIG. 16 is a top isometric view of the device of FIG. 1 disposed within a container; and

FIG. 17 is a partial cross-sectional view taken generally along the lines 17-17 of FIG. 16.

### DETAILED DESCRIPTION OF THE PREFERRED EMBODIMENTS

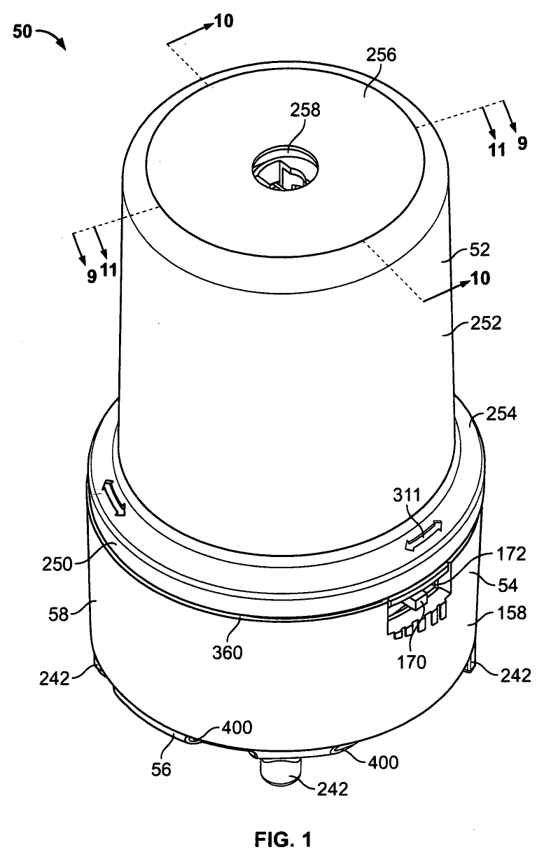

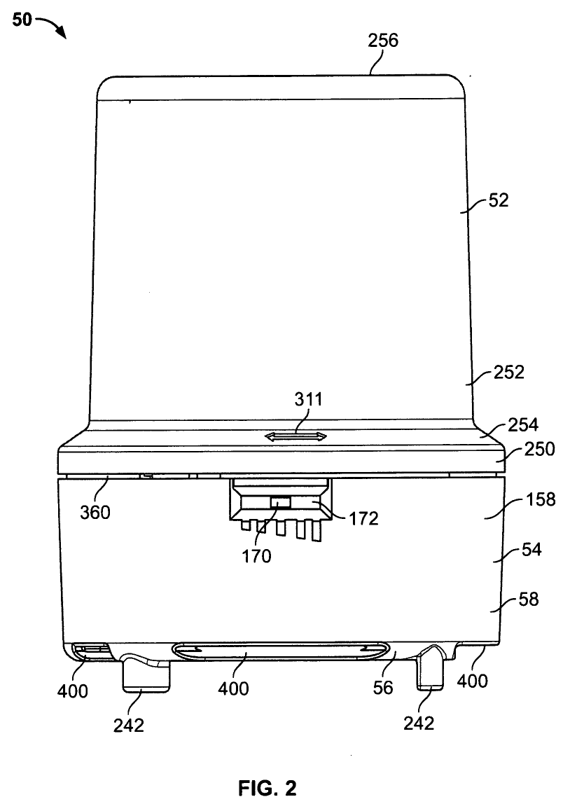

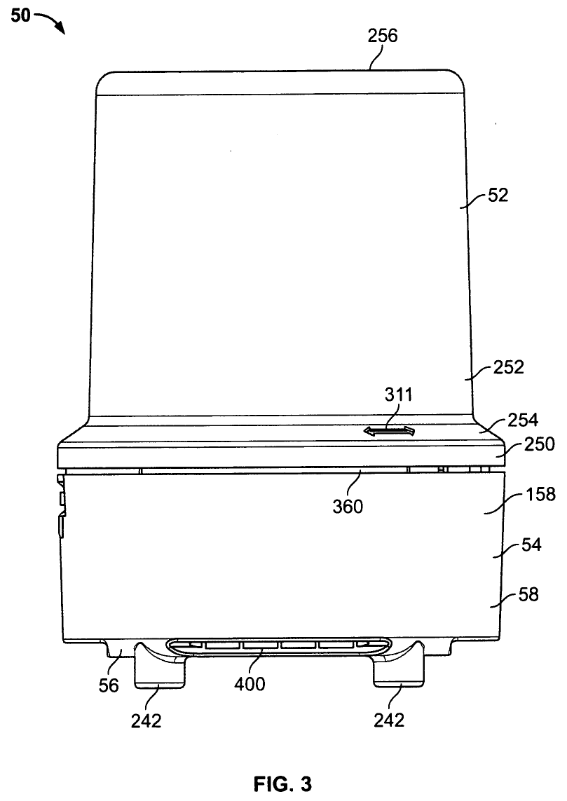

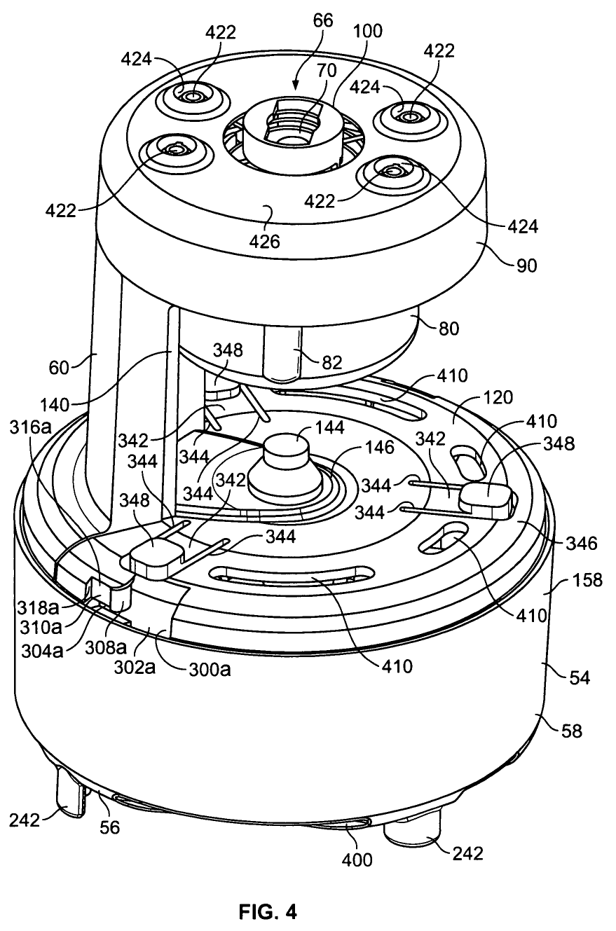

An active material emitting device 50 is illustrated in FIGS. 1-17. Referring to FIGS. 1-3, the device 50 generally includes a cover portion 52 and a base portion 54. The base portion 54 generally includes a base 56 and a housing 58 disposed on the base 56 for enclosing control circuitry (described hereinafter) for the device 50. As seen in FIGS. 4-6, a column 60 extends upwardly from the housing 58 and is preferably integral with the housing 58. Further, a support platform 62 extends substantially transversely from the column 60 in a cantilevered fashion and is preferably integral with the column 60. The support platform 62 includes an active material dispenser in the form of an atomizer assembly 66 that extends through a center portion 68 thereof.

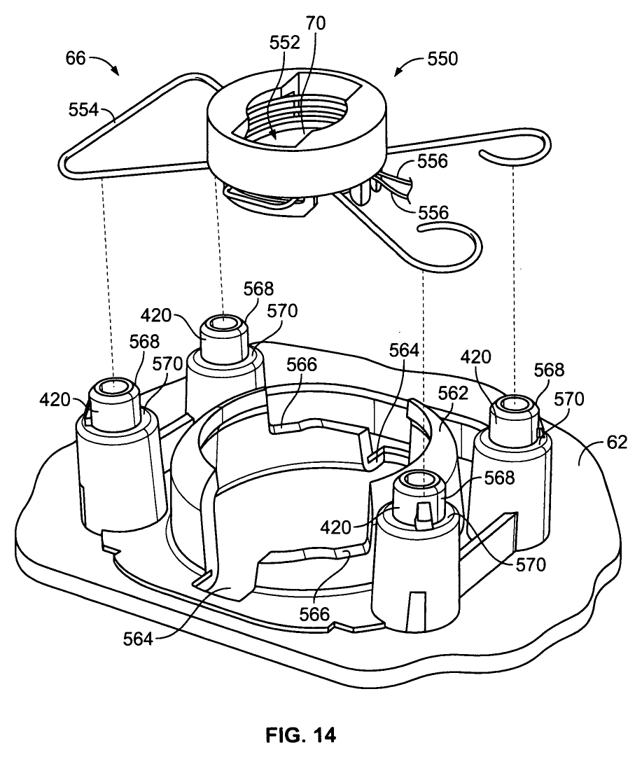

Any of the atomizer assemblies described in any of the patents incorporated by reference herein may be utilized as the atomizer assembly 66 (or as any of the atomizer assemblies described herein). In general, these assemblies apply an alternating voltage to a piezoelectric element to cause the element to expand and contract. The piezoelectric element is coupled to a perforated orifice plate 70 (FIG. 14), which in turn is in surface tension contact with a liquid source. The expansion and contraction of the piezoelectric element causes the orifice plate 70 to vibrate up and down whereupon liquid is driven through the perforations in the orifice plate 70 and is then emitted upwardly in the form of aerosolized particles. The atomizer assembly 66 is described in greater detail hereinafter with respect to FIG. 14.

Preferably, a container 80 having an active material therein, preferably a liquid fragrance, is inserted into the active material dispenser adjacent the atomizer assembly 66 for emission of the active material therefrom. The container 80 is preferably inserted adjacent the atomizer assembly 66 as discussed in detail with respect to FIG. 14. The container 80 includes a wick 82 in communication with the active material therein and extending through a top portion thereof, wherein the wick 82 transports active material from the container 80 to the atomizer assembly 66. The active material may alternatively be an insecticide, an insect repellant, an insect attractant, a disinfectant, a sanitizer, an air purifier, an aromatherapy scent, an antiseptic, an odor eliminator, an air-freshener, a deodorizer, or any other active ingredient(s) that are usefully dispersed into the air.

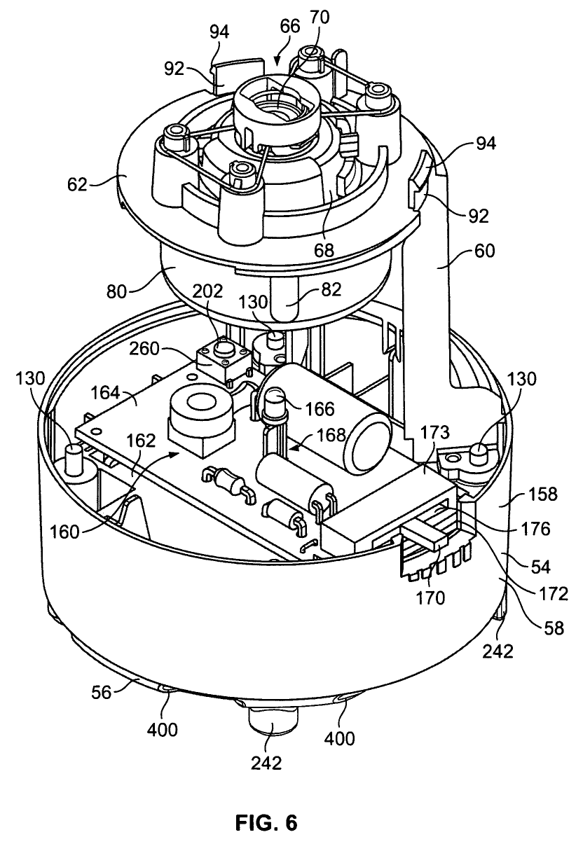

Referring to FIG. 4, a cap 90 may be disposed over the atomizer assembly 66 to hide the components of the atomizer assembly 66. Preferably, as seen in FIGS. 4 and 6, the support platform 62 includes a plurality of upwardly extending projections 92 extending therefrom, wherein outwardly extending projections 94 extend from the upwardly extending projections 92. The outwardly extending projections 94 are adapted to engage an annular lip 96 extending from an inner periphery 98 of the cap 90 to secure the cap 90 over the atomizer assembly 66. The cap 90 further includes a central circular aperture 100 therein such that active material emitted from the atomizer assembly 66 is directed through the aperture 100.

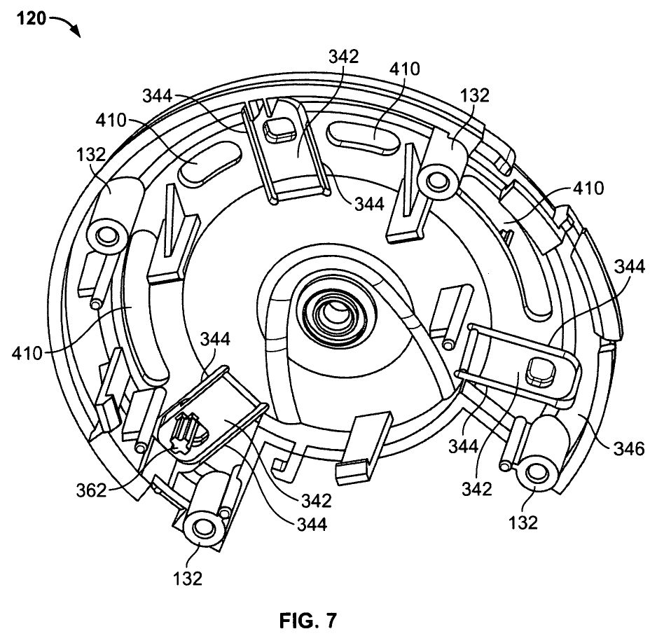

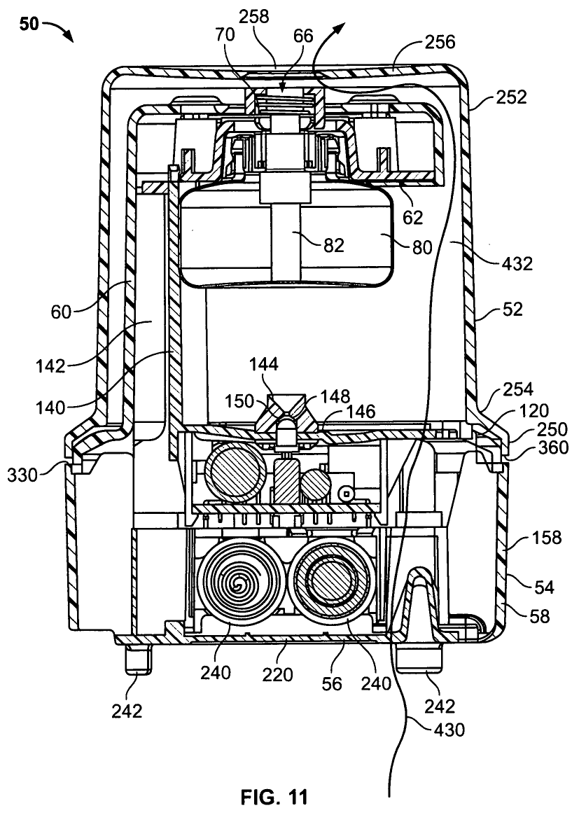

Referring to FIGS. 4, 5, and 7, the base portion 54 further includes a housing cover 120 disposed atop the housing 58. The housing cover 120 is preferably attached to the base portion 54 by welding or otherwise securing projections 130 (FIG. 6) extending upwardly from the base portion 54 within standoffs 132 (FIG. 7) extending downwardly from the housing cover 120. The housing cover 120 further includes an upwardly extending column 140 that interfits with the column 60 extending from the housing 58 when the housing cover 120 is disposed on the housing 58 to form a channel 142 (FIG. 11). Preferably, wires (not shown) extending from the electrical components of the control circuitry to the atomizer assembly 66 are disposed in the channel 142 to hide and protect the wires. Also preferably, the columns 60, 140 are formed of a transparent or translucent material, preferably a clarified material, such as clarified propylene, so that the columns 60, 140 allow light to pass therethrough. Still further, the housing cover 120 includes a light control device 144, such as a light diffuser, light pipe, lens, or the like, in a center portion 146 thereof, wherein the light control device 144 is preferably secured to or integral with the housing cover 120. The light control device 144 generally includes a cavity 148 in a bottom portion 150 thereof, wherein the light control device 144 may take any form, including any of the embodiments disclosed in copending U.S. application Ser. No. 11/542,370, the disclosure of which is hereby incorporated by reference.

As seen in FIG. 6, the housing 58 of the device 50 includes a cylindrical wall 158 that encloses control circuitry shown at 160. In particular, the base 56 includes a support structure 162 extending upwardly therefrom that supports a printed circuit board (PCB) 164. An LED 166 is operatively connected to and extends upwardly from a central portion 168 of the PCB 164. As best seen in FIGS. 1, 2, 5, and 6, an emission frequency actuator arm 170 extends through a rectangular aperture 172 in the cylindrical wall 158. The emission frequency actuator arm 170 is operatively connected to a slide switch 173, wherein the slide switch 173 is operatively connected to the PCB 164. The actuator arm 170 preferably includes five selectable positions that control the emission frequency of the atomizer assembly 66. Specifically, the actuator arm 170 is movable along a slot 176 in the slide switch 173 to one of five detent positions. A cutout 180 is disposed within the cylindrical wall 158 for movement of the actuator arm 170 therein. Movement of the actuator arm 170 within the slot 176 indicates to the slide switch 173 the current position of the actuator arm 170. The positions of the slide switch 173 are detected by the PCB 164. Components mounted on the PCB 164 control the atomizer assembly 66 corresponding to the position of the actuator arm 170, wherein each of the positions correspond to different time intervals that define the dwell time or the time between subsequent emission of puffs of active material by the atomizer assembly 66. As discussed above, wires extend from the PCB 164 to the atomizer assembly 66 to actuate the atomizer assembly 66 in dependence upon the position of the actuator arm 170.

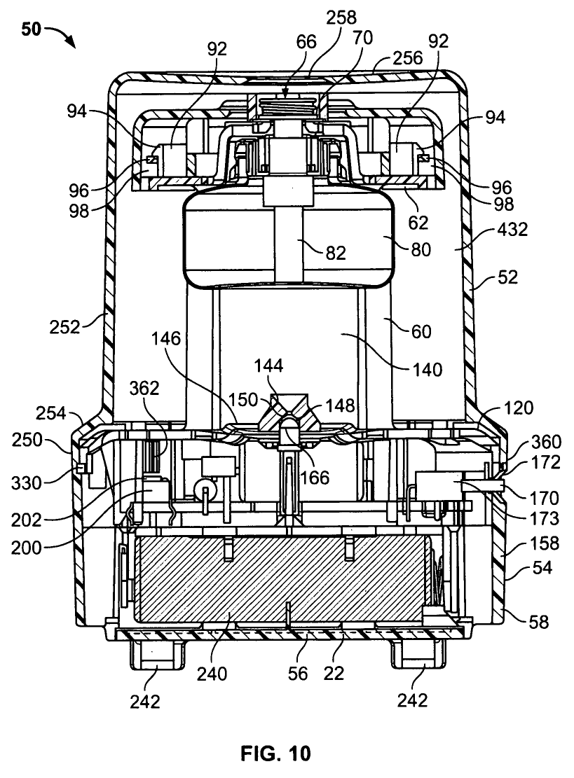

The PCB 164 further includes a switch 200 having a depressable button 202 extending upwardly therefrom, as best seen in FIGS. 6 and 10. Depression of the button 202 turns the LED 166 on or off depending on the current state of the LED 166. The actuation of the button 202 and the operation of the control circuitry 160 will be discussed in greater detail hereinafter.

The PCB 164 includes programmable device in the form of an application specific integrated circuit (ASIC) incorporated therein, wherein the ASIC operates in conjunction with further electrical components to control the energization of the LED 166 described above and the atomizer assembly 66. The operation of the ASIC is described in detail in U.S. application Ser. No. 11/265,738, the disclosure of which is hereby incorporated by reference.

As noted above, the housing 58 encloses the PCB 164 and other control circuitry and the LED 166, as seen in FIGS. 10 and 11. When the housing cover 120 is attached to the housing 58, as discussed in detail above, the LED 166 is disposed in the cavity 148 located at the bottom portion 150 of the light control device 144, such that light emitted from the LED 166 may be reflected and refracted by the light control device 144.

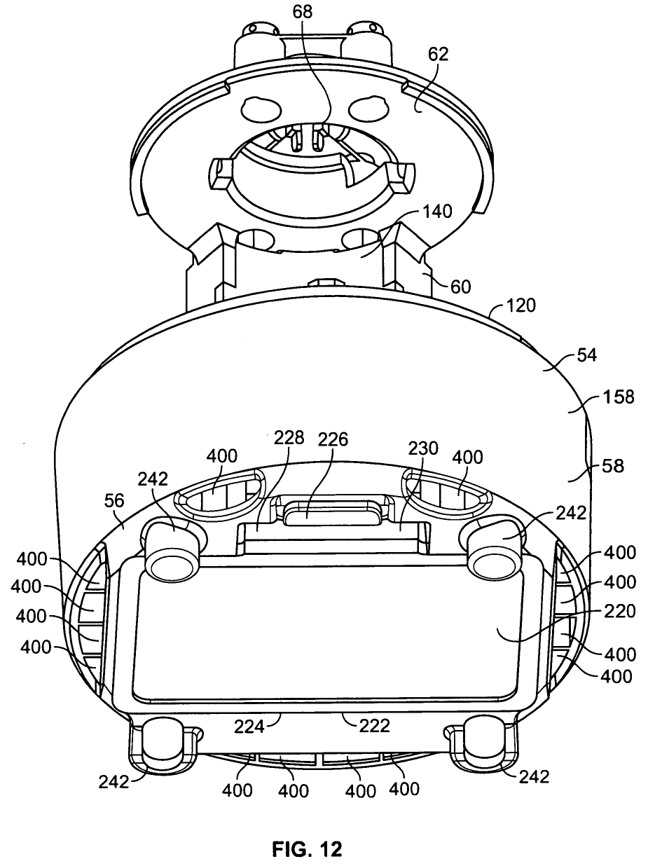

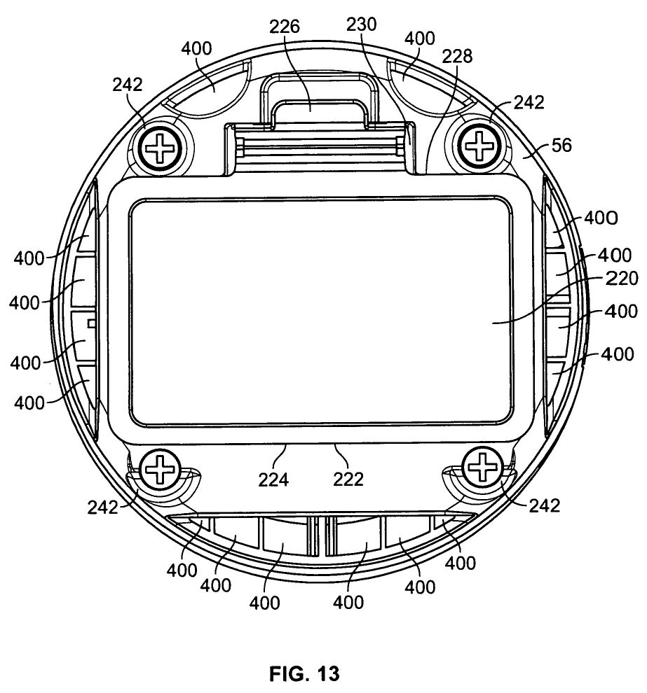

Referring to FIGS. 12 and 13, the base portion 54 of the device 50 includes a battery door 220 that includes a hinge 222 at a first end 224 thereof and a latching mechanism 226 at a second end 228 thereof. The latching mechanism 226 interacts with a locking recess 230 in the base portion 54 to hold the battery door 220 in a closed position. The latching mechanism 226 may be flexed to release the latching mechanism 226 from the locking recess 230, such that the battery door 220 may pivot about the hinge 222 to open the battery door 220 and allow access to a battery compartment 231.

As further seen in FIGS. 12 and 13, the base portion 54 of the device 50 includes two batteries 240 that preferably provide direct current that is converted into high-frequency alternating current power that is selectively applied to the atomizer assembly 66 and the LED 166. Optionally, the device 50 may be powered by alternating household current, which is rectified, converted to high-frequency alternating current power, and reduced in voltage and applied intermittently to the atomizer assembly 66 and/or the LED 166. The batteries 240 may be any conventional dry-cell battery such as “A”, “AA”, “AAA”, “C”, and “D” cells, button cells, watch batteries, and solar cells, but preferably, the batteries 240 are “AA” or “AAA” cell batteries. Although two batteries are preferred, any number of batteries that would suitably fit within the device 50 and provide adequate power level and service life may be utilized.

The base portion 54 may further include optional feet 242 extending therefrom to aid in stabilizing the active material emitting device 50. Although four feet 242 are depicted, any suitable number of feet 242 for stabilizing the device 50 may be utilized.

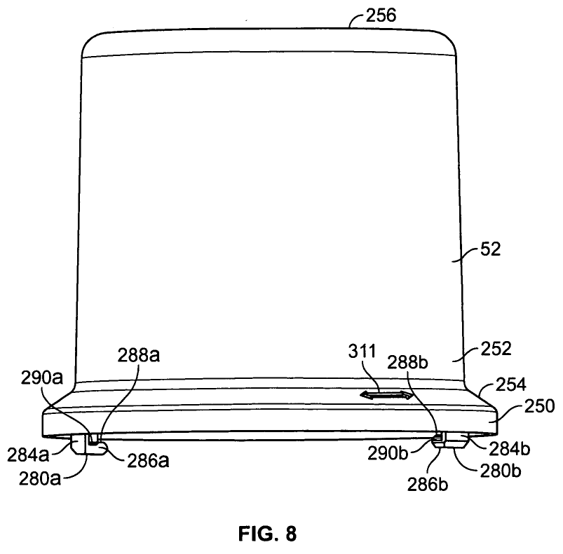

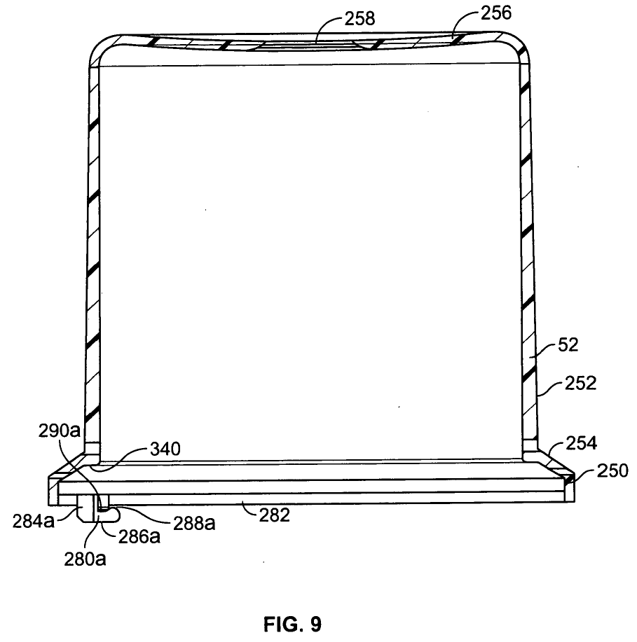

Referring specifically to FIGS. 8 and 9, the cover portion 52 includes a lower cylindrical wall 250 having a first diameter and an upper cylindrical wall 252 having a second diameter that is preferably smaller than the first diameter. An angled wall 254 joins the lower cylindrical wall 250 to the upper cylindrical wall 252. The lower cylindrical wall 250 has a height that is much less than a height of the upper cylindrical wall 252. The cover portion 52 further includes a circular top wall 256 adjacent the upper cylindrical wall 252 and having a circular opening or aperture 258 disposed in a central portion thereof.

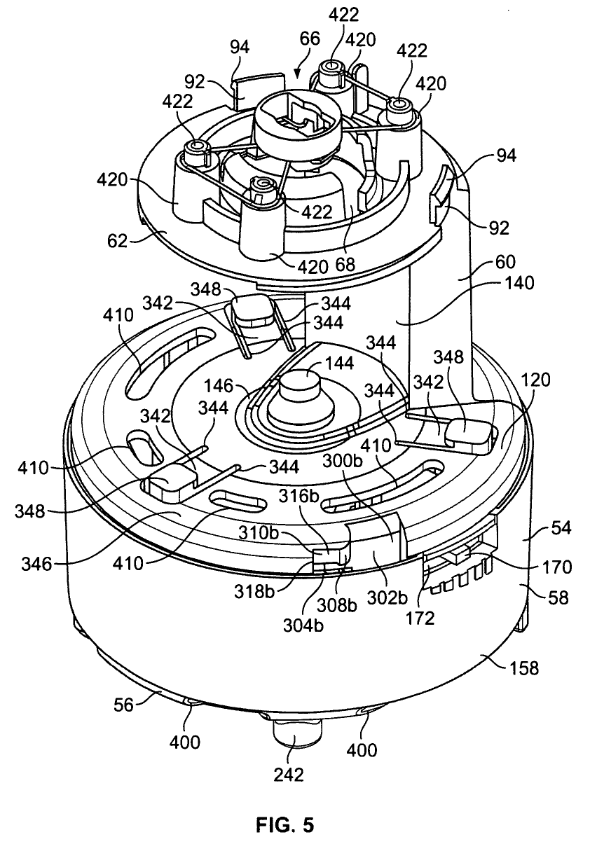

As seen in FIGS. 10 and 11, the cover portion 52 is positioned over the base portion 54 during use of the device 50. Specifically, as seen in FIGS. 8 and 9, the cover portion 52 includes first and second projections 280a, 280b extending downwardly from and integral with an inner surface 282 of the lower cylindrical wall 250. The first and second projections 280a, 280b are preferably, although not necessarily, disposed opposite one another. Each projection 280a, 280b includes a first vertical portion 284a, 284b and a horizontal portion 286a, 286b that is transverse to the respective vertical portion 284a, 284b. Protuberances 288a, 288b extend upwardly from upper surfaces 290a, 290b of the vertical portions 284a, 284b. The base portion 54 includes first and second grooves 300a, 300b formed within the housing cover, as best seen in FIGS. 4 and 5. The grooves 300a, 300b include first portions 302a, 302b and second portions 304a, 304b, wherein the first portions 302a, 302b have a width greater than a width of the second portions 304a, 304b. Projections 308a, 308b extend from walls 310a, 310b forming one side of each of the second portions 304a, 304b.

Referring to FIGS. 10 and 11, when the cover portion 52 is placed atop the base portion 54, the upper cylindrical wall 252 surrounds the columns 60, 140, the support platform 62, and the atomizer assembly 66 and the lower cylindrical portion 250 abuts an upper periphery 330 of the cylindrical wall 156 of the base portion 54. The cover portion 52 is further positioned over the base portion 54 such that the atomizer assembly 66 is aligned with the aperture 258 in the circular top wall 256 of the cover portion 52. The aperture 258 provides an outlet for active material that is atomized by the atomizer assembly 66 and emitted from the device 50.

As best seen in FIG. 9, the cover portion 52 further includes a downwardly facing ledge 340 formed between an intersection of the upper cylindrical wall 252 and the angled connecting wall 254 of the cover portion 52. As seen in FIGS. 4, 5, and 7, the housing cover 120 includes a plurality of spring fingers 342 in part defined by slots 344 that extend inwardly from a periphery 346 of the housing cover 120. Each of the spring fingers 342 includes a projection 348, as best seen in FIGS. 4 and 5, extending upwardly therefrom. The cover portion 52 is attached to the base portion by inserting the first and second projections 280a, 280b into the first portions 302a, 302b of the grooves 300a, 300b. Thereafter, the cover portion 52 is rotated clockwise (as shown by the arrow in FIGS. 1-3 and 8) as the cover portion 52 is pushed downwardly such that the protuberances 288a, 288b extending upwardly from the horizontal portions 286a, 286b ride over the projections 308a, 308b extending inwardly from the walls 310a, 310b defining the second portions 304b, 304b of the grooves 300a, 300b. Once the protuberances 288a, 288b pass the projections 308a, 308b, the user releases the cover portion 52 and the protuberances 288a, 288b move into grooves 316a, 316b formed between ends 318a, 318b of the grooves 300a, 300b and the projections 308a, 308b to prevent removal of the cover portion 52. As the protuberances 288a, 288b move into the grooves 316a, 316b, the downwardly facing ledge 340 rides on top of the spring fingers 342, which are resilient and act as upwardly biased flexures. Thus, as seen in FIGS. 10 and 11, the cover portion 52 is biased in a position such the protuberances 288a, 288b are retained within the grooves 316a, 316b formed between the ends 318a, 318b of the grooves 300a, 300b and the projections 308a, 308b. To remove the cover portion 52, the cover portion 52 must be pressed downwardly and rotated counterclockwise such that the protuberances 288a, 288b pass the projections 308a, 308b.

As seen in FIGS. 1-3, 10, and 11, a gap 360 between the lower cylindrical portion 250 of the cover portion 52 and the upper periphery 330 of the cylindrical wall 156 of the base portion 54 allows movement of the cover portion 52 in a vertical direction relative to the housing 58. A user may therefore exert downward pressure on the cover portion 52 against the bias of the resilient spring fingers 342. Such pressure allows the cover portion 52 to move downwardly until the lower cylindrical portion 250 of the cover portion 52 abuts the upper periphery 300 of the cylindrical wall 156. As the cover portion 52 moves downwardly, the downwardly facing ledge 340 flexes the spring fingers 342 downwardly. As the spring fingers 342 move downwardly, a projection 362 (FIGS. 7 and 10) extending downwardly from a spring finger 342 that is aligned with the depressable button 202 contacts the depressable button 202, thereby activating the switch 200. A change in state of the switch 200 is detected by the PCB 164 and the LED 166 is turned on (for a predetermined time frame) or off depending on the current state of the LED 166, as described in greater detail hereinafter.

The cover portion 52 is preferably made of a transparent or translucent material, such as glass and/or a polymeric resin, such that the cover portion 52 functions as a light diffuser. All or portions of an inner surface 380 and/or an outer surface 382 of the cover portion 52 may include a surface treatment, such as a frosted surface, a coating, a roughened surface, a textured surface, and/or the like, in order to provide an even dispersion of light through the cover portion 52. The cylindrical wall 156 of the base portion 54 is preferably made a material similar to that of the cover portion 52, but is preferably not translucent or transparent in order to obscure the components of the base portion 54. Optionally, a decal or other obscuring element may be positioned on the upper cylindrical wall 252 of the cover portion 52.

Various venting mechanisms are disposed in the device 50 to aid in dispersing the active material to an area surrounding the device 50. Referring to FIGS. 12 and 13, apertures 400 extend through the base portion 54 to form channels for the flow of ambient air therethrough. Optionally, as seen in FIGS. 1-6, the apertures 400 extend upwardly into a portion of the housing 58 such that air can move both horizontally and vertically into the base portion 54. Also, any number of apertures 400 could be utilized. Referring next to FIGS. 4, 5, and 7, apertures 410 extend through the housing cover 120. The apertures 400 and 410 may be of any size and shape that could be easily manufactured and which do not unduly interfere with the components or features of the base portion 54 and housing cover 120, respectively, and which also would not interfere with the stability and strength of same.

Referring to FIGS. 4 and 5, posts 420 surrounding and supporting the atomizer assembly 66 and extending upwardly from the support platform 62 include channels 422 therethrough. When the cap 90 is disposed atop the support platform 62, one or more apertures 424 in an upper surface 426 of the cap 90 are aligned with the channels 422 to allow air flow therethrough.

An example of air flow through the device 50 is depicted by the arrow 430 in FIG. 11. In particular, ambient air generally flows through the apertures 400 upwardly through the housing 58 and past the components therein. Thereafter, air generally flows through the apertures 410 in the housing cover 120 and into a space 432 (FIGS. 10 and 11) formed within the upper cylindrical wall 252 of the cover portion 52 and disposed above the housing cover 120. The air then generally moves around the support platform 62 and around a periphery of the cap 90 and out of the device 50 through the aperture 258 in the cover portion 52. Optionally, a portion of the air may move through the channels 422 through the platform 62 and the apertures 424 in the cap 90 and out of the device through the aperture 258 in the cover portion 52. This air flow aids in carrying active material that is emitted by the atomizer assembly 66 away from the device 50 and into the surrounding area.

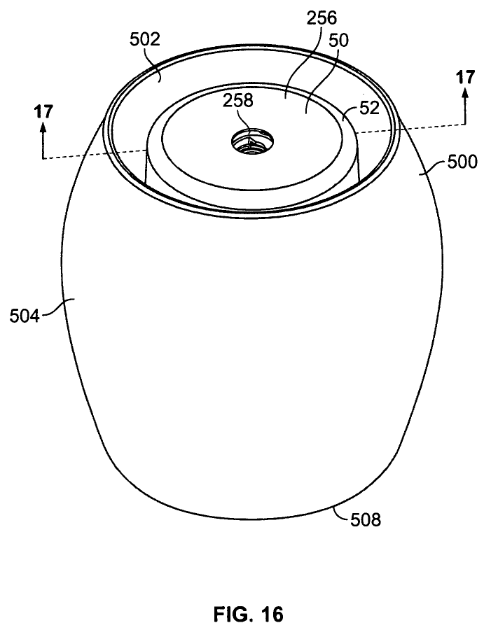

As seen in FIG. 16, the active material emitting device 50 may be placed into a container 500 for use thereof, or may be placed on a surface and used alone. The container 500 also preferably acts as a light diffuser and may be made of a transparent or translucent material, such as glass and/or a polymeric resin. All or portions of an inner surface 502 and/or an outer surface 504 of the container may include a surface treatment, such as a frosted surface, a coating, a roughened surface, a textured surface, and the like, to provide relatively even dispersion of light through the container 500. Optionally, one or more images may be formed on the container 500 by placing a sticker or other image-forming device (such as a decal) on a surface thereof. Still optionally, etchings may be formed in the light control device 144 to project a shape or shadow, as desired. Although one shape of container 500 is depicted herein, any shape of container 500 is contemplated, as long as the device 50 fits sufficiently therein.

Referring to FIGS. 1, 6, and 17 the active material emitting device 50 is disposed within the container 500 such that the feet 242 of the device 50 rest upon an upper surface 506 of a bottom portion 508 of the container 500. Preferably, the device 50 fits within the container 500 without portions of the upper cylindrical wall 252 of the cover portion 52 or the cylindrical wall 158 of the housing 58 touching the inner surface 502 of the container 500.

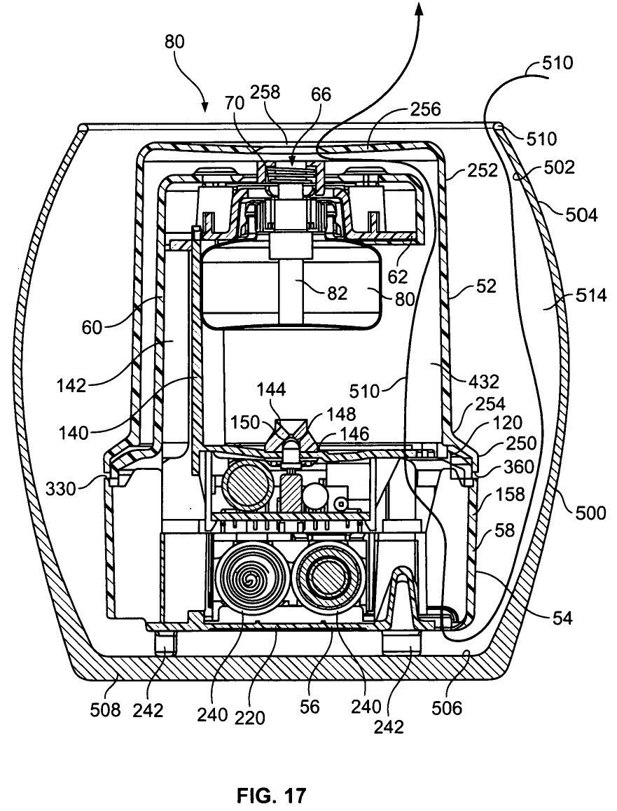

A further example of air flow through the container 500 and the device 50 is depicted by the arrow 510 in FIG. 17. The air flow is similar to the air flow 430 of FIG. 11, but the air first travels over a top edge 512 of the container 500 and through a space 514 between the device 50 and the container 500 before entering the housing 58 of the device 50. Once air enters the device 50, the air thereafter generally travels in the same manner as described with respect to FIG. 11.

The operation of the active material emitting device 50 of FIGS. 1-17 will now be described in detail. When a user desires to operate the device 50, the battery door 220 is opened using the latching mechanism 226 and batteries 240 are placed within the device 50. To insert a container 80 having an active material therein, the cover portion 52 is removed from the device 50 as described in detail above, an old container 80 is removed and/or a new container 80 is inserted, and the cover portion 52 is placed back onto the device 50 again as described in detail above. The order of insertion of the batteries 240 and a container 80 may be reversed, but as soon as both are inserted, the device 50 begins emitting the active material.

The user may then move the actuator arm 170 (FIGS. 1, 2, 5, 6, and 10) to set the dwell time for emission of the active material. Once the dwell time is set, the device 50 may be placed in a container 500. It is not until the user depresses the cover portion 52, as described in detail above, that the LED 166 will turn on. The LED 166 can be turned off by a subsequent depression of the cover portion 52 or the LED 166 will automatically shut off after a predetermined time period, such as three or four hours.

Referring next to FIG. 14, an atomizer assembly 66 that may be utilized in the active material emitting device 50 is shown in detail. The atomizer assembly 66 includes a piezoelectric actuator 550 having a piezoelectric element 552 and orifice plate 70 similar or identical to those described in Helf et al. U.S. Pat. No. 6,896,193. The actuator 550 is mounted on the posts 420 by a metal support wire 554 that extends through the actuator 550 and around the posts 420. An outer circumferential portion of the orifice plate 70 is in contact with the piezoelectric actuator 550. Eighty-four perforations or holes (not seen due to the scale of the drawings) of nominally equal diameter (within a tolerance range as noted in greater detail hereinafter) extend through the orifice plate 70. In the preferred embodiment, the perforations in the orifice plate 70 are substantially circular in shape at the intersections of the holes with an upper surface of the orifice plate 70. Preferably, the piezoelectric actuator 550 is identical or similar to that found in commercially available electronic air freshening apparatus sold under the present assignee's WISP® trademark.

The piezoelectric element 552 is connected by wires 556 to the PCB 164. The wires 556 supply an alternating electrical voltage produced by circuitry disposed on the PCB 164 to opposite sides of the piezoelectric actuator 550. A diameter of the actuator 550 alternately increases and decreases in size when alternating electrical voltages are applied to the piezoelectric actuator 550, thereby causing the orifice plate 70 to vibrate up and down due to the contact of the actuator 550 with the orifice plate 70. The orifice plate 70 is, in turn, in contact with fluid supplied by the wick 82. The up and down vibration of the orifice plate 70 causes liquid to be driven through the perforations or holes in the orifice plate 70 and the liquid is emitted upwardly in the form of aerosolized particles.

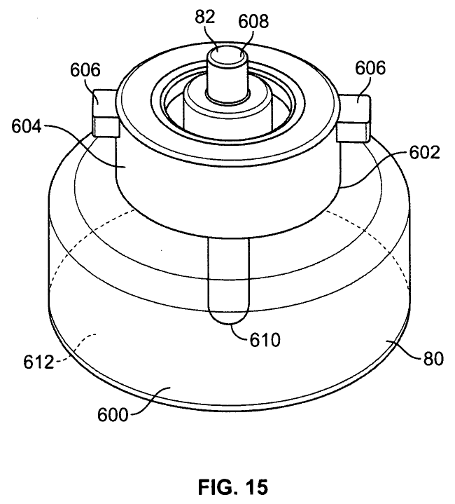

Insertion of the container 80 into the support platform 62 will now be discussed in detail with respect to FIGS. 14 and 15. The support platform 62 includes an opening 560 therein that receives the replaceable container 80. The support platform 62 includes an upwardly extending cylindrically shaped reservoir mounting wall 562. The mounting wall 562 includes two opposing bayonet slots 564 formed therein and walls 566 define corresponding circumferentially extending detents forming a part of the bayonet slots 564. The posts 420 extend upwardly from the support platform 62 adjacent the mounting wall 562 wherein each post 420 includes a smaller projection 568 extending upwardly from a top portion 570 thereof.

As seen in FIG. 15, the container 80 comprises a transparent cylindrical container 600 with a neck 602. A combination plug and wick holder 604 is affixed to the neck 602, wherein the plug and wick holder 604 includes a pair of laterally extending mounting lugs 606. An upper end 608 of the wick 82 extends beyond the neck 602 and a lower end 610 of the wick 80 is disposed within the container 80 toward a bottom surface 612 thereof. The wick 82 transfers liquid by capillary action from within the container 80 to the upper end 608 of the wick 82. The container 80 is inserted into the support platform 62 by aligning the lugs 606 with the bayonet slots 564 and pushing the container 80 upwardly, thereby inserting the lugs 606 into the respective bayonet slots 564. The container 80 is thereafter rotated to force the lugs 606 to engage with the walls 566 defining the detent portions of the respective bayonet slots 564 to secure the container 80 within the device 50.

### INDUSTRIAL APPLICABILITY

The active material emitting devices described herein emit an active material therefrom using an atomizer assembly. One or more venting mechanisms may be incorporated into the devices in order to effectively disperse the active material. Optionally, the device may also include an LED to create the look and feel of a pillar-type candle.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. An active material emitting device, comprising:
an ultrasonic atomizer disposed within the device for volatilizing an active material;
an opening disposed adjacent the ultrasonic atomizer for emitting the volatilized active material therethrough; and
a vent disposed in the device, wherein the vent creates an air passageway for air to enter the device and exit the device through the opening to carry the volatilized active material away from the device.

2. The active material emitting device of claim 1, wherein the device includes a base portion and a cover portion disposed atop the base portion and wherein the vent is disposed through the base portion.

3. The active material emitting device of claim 2, wherein the base portion includes a housing and a housing cover is disposed over the housing and includes at least one aperture therethrough to further carry air through the device.

4. The active material emitting device of claim 3, wherein a column extends upwardly from the housing and a support platform extends from the column to carry the ultrasonic atomizer.

5. The active material emitting device of claim 4, wherein at least one uninterrupted channel extends through the support platform to further carry air through the device.

6. The active material emitting device of claim 5, wherein a cap is disposed over the support platform and the cap includes at least one aperture in communication with the at least one uninterrupted channel.

7. The active material emitting device of claim 6, wherein an airflow path created through the device flows into the device through the vents in the base portion, through the at least one aperture in the housing cover, through the at least one uninterrupted channel in the support platform, and out the opening in the cover portion.

8. The active material emitting device of claim 7, wherein a light emission device in the form of a light-emitting diode (LED) is disposed within the device and a light control device is disposed over the LED.

9. The active material emitting device of claim 7, wherein the ultrasonic atomizer assembly is periodically operated to release an active material.

10. An active material emitting device, comprising:
a base portion;
a cover portion disposed over the base portion;
a housing extending upwardly from the base portion and including an ultrasonic atomizer;
an opening disposed in the cover portion and aligned with the ultrasonic atomizer for emitting a volatilized active material therethrough; and
a vent extending through the base portion to create an air passageway with the opening.

11. The active material emitting device of claim 10, further including a plurality of vents disposed through the base portion.

12. The active material emitting device of claim 11, wherein a housing cover is disposed over the housing and includes at least one aperture therethrough to further carry air through the device.

13. The active material emitting device of claim 12, wherein a column extends upwardly from the housing and a support platform extends from the column to carry the ultrasonic atomizer.

14. The active material emitting device of claim 13, wherein at least one uninterrupted channel extends through the support platform to further carry air through the device.

15. The active material emitting device of claim 14, wherein an airflow path created through the device flows into the device through the vents in the base portion, through the at least one aperture in the housing cover, through the at least one uninterrupted channel in the support platform, and out the opening in the cover portion.

16. The active material emitting device of claim 15 disposed in a container.

17. The active material emitting device of claim 10, wherein a light emission device in the form of a light-emitting diode (LED) is disposed within the device and a light control device is disposed over the LED.

18. A method of dispensing an active material, the method comprising the steps of:
providing an active material emitting device having a base portion, a cover portion, and an ultrasonic atomizer that volatilizes an active material and dispenses same through an opening in the cover portion; and
creating an ambient air flow into the device through the base portion, through the device, and out the opening.

19. The method of claim 18, further including the step of providing a vent in the base portion such that ambient air can move therethrough.

20. The method of claim 19, further including the step of periodically activating the ultrasonic atomizer, thereby creating a flow of air from within the device out the opening.
